(19) United States
(12) Patent Application Publication
(10) Pub. No.: US 2019/0366688 A1
(43) Pub. Date: Dec. 5, 2019

(54) LAMINATE, MOLDED ARTICLE, AND METHOD FOR PRODUCING MOLDED ARTICLE

(71) Applicant: IDEMITSU UNITECH CO., LTD., Tokyo (JP)

(72) Inventors: Ryosuke ARAKI, Chiba (JP); Kaname KONDO, Chiba (JP)

(73) Assignee: IDEMITSU UNITECH CO., LTD., Tokyo (JP)

(21) Appl. No.: 16/485,556

(22) PCT Filed: Feb. 13, 2018
(86) PCT No.: PCT/JP2018/004871

§ 371 Date: Aug. 13, 2019

(30) Foreign Application Priority Data
Feb. 14, 2017 (JP) 2017-024920
Sep. 5, 2017 (JP) 2017-170273

(51) Int. Cl. B32B 15/085; B32B 7/12; B29C 45/14

(52) U.S. Cl. CPC B32B 15/085; B32B 7/12; B29K 2623/12; B32B 2255/06; B32B 2255/26; B29C 45/14

(57) ABSTRACT

Provided is a laminate containing, in the indicated order, a resin layer that contains a polyolefin, an adhesive layer, an undercoat layer, and a metal layer that contains metal or metal oxide.

### TECHNICAL FIELD

The invention relates to a laminate, a molded article and a method for producing the molded article.

### BACKGROUND ART

Plating has been used so far as a method of providing a resin molded product with a metal-like design. However, the plating generates a large amount of liquid wastes and hazardous substances, and therefore a substitute technology has been actively examined for the purpose of reducing an environmental load in recent years. As the substitute technology, such a method is developed, in which a metal thin film is formed on a plastic sheet by vapor deposition, and integrated with a housing by various decorative molding methods to be provided with the metal-like design.

Patent Document 1 discloses a technology using an undercoat agent for a plastics with an aluminum thin film, containing a specific acryl copolymer, an isocyanate composition and an epoxy group-containing silicon compound.

Patent Document 2 discloses an undercoat agent containing an acryl copolymer having a carboxylate anion group, and a polyaziridine compound having at least 3 aziridinyl groups.

### RELATED ART DOCUMENTS

### Patent Documents

Patent Document 1: JP-A-2016-74888

Patent Document 2: JP-A-2011-195835

### SUMMARY OF THE INVENTION

However, even if the technology described in Patent Document 1 is applied to a polyolefin-based sheet, adhesion between the sheet and an undercoat layer is weak, and therefore crazing is caused in a metal layer, or luminance is reduced by a rainbow phenomenon in which rainbow luminance unevenness is caused, or a whitening phenomenon by water vapor.

Further, even if the technology described in Patent Document 2 is applied to the polyolefin-based sheet, the adhesion between the sheet and the undercoat layer is insufficient by surface treatment with corona discharge or the like, and when molding processing is performed under a high temperature, interference fringes or crazing is caused in the metal layer.

An object of the invention is to provide a laminate from which a molded article having an excellent appearance can be produced and which has high inter-layer adhesion.

The findings described below have been found out by study by the present inventors. More specifically, while a sheet of polymethyl methacrylate, a polyester film or the like has a certain degree of adhesion, the sheet easily permeates water vapor, and therefore has a problem of a whitening phenomenon caused by corrosion of the metal layer. Meanwhile, a polyolefin sheet is hard to permeate water vapor, and therefore can prevent corrosion of the metal layer, and is hard to cause the whitening phenomenon. However, a polyolefin has low adhesion, and therefore requires use of a flexible layer as a layer for allowing a resin layer that contains the polyolefin to adhere to the metal layer, and has an issue of easily causing crazing in the metal layer due to its flexibility.

The present inventors have found as a result of further study that an adhesive layer adhering to a polyolefin is provided on a resin layer that contains a polyolefin to further form an undercoat layer thereon, and a metal layer is provided thereon, whereby a laminate having excellent adhesion can be formed, and a molded article having high luminance and an excellent metal-like appearance can be produced, and the invention has been completed.

According to the invention, a laminate and the like described below are provided.

1. A laminate, comprising, in the indicated order, a resin layer that contains a polyolefin, an adhesive layer, an undercoat layer and a metal layer that contains metal or metal oxide.

2. The laminate according to 1, wherein the adhesive layer contains one or more resins selected from the group consisting of a urethane resin, an acrylic resin, polyolefin and polyester.

3. The laminate according to 1 or 2, wherein the undercoat layer contains one or more resins selected from the group consisting of a urethane resin, an acrylic resin, polyolefin and polyester.

4. The laminate according to any one of 1 to 3, wherein the undercoat layer contains a resin component and a curing agent component, and a content proportion of the resin component to the curing agent component is 35:4 to 35:40 in a mass ratio.

5. The laminate according to any one of 1 to 4, wherein the resin layer that contains the polyolefin contains polypropylene.

6. The laminate according to 5, wherein an isotactic pentad fraction of the polypropylene is 80 mol % or more and 98 mol % or less.

7. The laminate according to 5 or 6, wherein a crystallization rate of the polypropylene at 130° C. is 2.5 min⁻¹ or less.

8. The laminate according to any one of 5 to 7, wherein the polypropylene has an exothermic peak of 1.0 J/g or more on a low-temperature side of a maximum endothermic peak in a curve of differential scanning calorimetry.

9. The laminate according to any one of 5 to 8, wherein the polypropylene contains a smectic form.

10. The laminate according to any one of 1 to 9, wherein the resin layer that contains the polyolefin contains no nucleating agent.

11. The laminate according to any one of 1 to 10, wherein a metal element contained in the metal layer is one or more selected from the group consisting of tin, indium, chromium, aluminum, nickel, copper, silver, gold, platinum and zinc.

12. The laminate according to any one of 1 to 11, wherein a metal element contained in the metal layer is one or more selected from the group consisting of indium, aluminum and chromium.

13. The laminate according to any one of 1 to 12, comprising a printed layer partly or wholly on a surface of the metal layer on a side opposite to the undercoat layer.

14. The laminate according to any one of 1 to 12, comprising a printed layer partly or wholly on a surface of the metal layer on a side of the undercoat layer

15. The laminate according to any one of 1 to 14, comprising a second adhesive layer on a surface of the resin layer on a side opposite to the adhesive layer.

16. A molded article of the laminate according to any one of 1 to 15.

17. The molded article according to 16, wherein the resin layer that contains the polyolefin in the molded article contains polypropylene, and an isotactic pentad fraction of the polypropylene is 80 mol % or more and 98 mol % or less.

18. The molded article according to 16 or 17, wherein the resin layer that contains the polyolefin in the molded article contains polypropylene, and a crystallization rate of the polypropylene at 130° C. is 2.5 min⁻¹ or less.

19. The molded article according to any one of 16 to 18, wherein the metal layer in the molded article contains indium or indium oxide, and glossiness measured from a surface on a side opposite to the adhesive layer across the resin layer that contains the polyolefin is 250% or more.

20. The molded article according to any one of 16 to 18, wherein the metal layer in the molded article contains aluminum or aluminum oxide, and glossiness measured from a surface on a side opposite to the adhesive layer across the resin layer that contains the polyolefin is 460% or more.

21. The molded article according to any one of 16 to 18, wherein the metal layer in the molded article contains chromium or chromium oxide, and glossiness measured from a surface on a side opposite to the adhesive layer across the resin layer that contains the polyolefin is 200% or more.

22. A method for producing a molded article, comprising molding the laminate according to any one of 1 to 15 to obtain the molded article.

23. The method for producing the molded article according to 22, wherein the molding is performed by attaching the laminate to a mold, and supplying a molding resin to integrate the molding resin with the laminate.

24. The method for producing the molded article according to 22, wherein the molding is performed by shaping the laminate so as to match a mold, attaching the shaped laminate to the mold, and supplying a molding resin to integrate the molding resin with the laminate.

25. The method for producing the molded article according to 22, wherein the molding comprises arranging a core material in a chamber box, arranging the laminate above the core material, reducing a pressure in the chamber box, heating and softening the laminate, and pressing the heated and softened laminate to the core material to coat the core material with the laminate.

The invention can provide a laminate from which a molded article having an excellent appearance can be produced and which has high inter-layer adhesion.

### BRIEF DESCRIPTION OF THE DRAWINGS

FIG. 1 is a schematic cross-sectional view of a laminate according to one aspect of the invention.

FIG. 2 is a schematic diagram of an apparatus used for producing a polypropylene sheet (a polyolefin resin layer) in Example 1.

### MODE FOR CARRYING OUT THE INVENTION

A laminate in one aspect of the invention comprises, in the indicated order, a resin layer that contains a polyolefin (hereafter, also referred to as “a polyolefin resin layer”), an adhesive layer, an undercoat layer and a metal layer that contains metal or metal oxide.

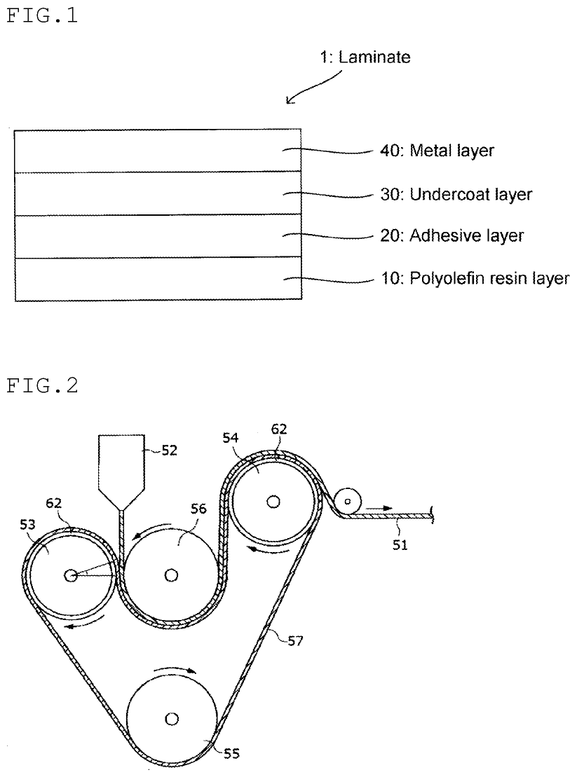

The laminate in one aspect of the invention is shown in FIG. 1.

In FIG. 1, a laminate 1 comprises a polyolefin resin layer 10, an adhesive layer 20, an undercoat layer 30 and a metal layer 40. It is to be noted that FIG. 1 is only for illustrating a layer structure, and an aspect ratio or a film thickness ratio is not necessarily accurate.

The laminate in one aspect of the invention has the above-described layer structure, and therefore has high inter-layer adhesion. Further, even when stress is applied to the laminate by thermoforming or the like, innumerable significantly fine cracks are generated in the metal layer, and therefore crazing having such a size as a visible level is not caused or hard to be caused. Further, a rainbow phenomenon caused by irregular reflection of light can be prevented owing to fineness of the innumerable cracks, and the polyolefin is used in the resin layer, whereby a whitening phenomenon is hard to occur. Accordingly, a molded article having high luminance and an excellent appearance can be produced.

Hereinafter, each layer will be described. In the present description, the term “x to y” shall express the range of numerical values of “x or more and y or less.”

### (Polyolefin Resin Layer)

As a polyolefin, polyethylene, polypropylene, a cyclic polyolefin or the like can be used. These polyolefins are hard to permeate water vapor, and therefore can suppress the whitening phenomenon caused by corrosion of the metal layer. Above all, the polypropylene is preferred.

The polypropylene is a polymer at least containing propylene. Specific examples thereof include homopolypropylene, a copolymer of propylene and olefin, and the like. The homopolypropylene is particularly preferred for the reason of heat resistance and hardness.

As the copolymer, a block copolymer or a random copolymer may be used, or a mixture thereof may also be used.

Specific examples of the olefin include ethylene, butylene, cycloolefin, and the like.

An isotactic pentad fraction of polypropylene is preferably 80 mol % or more and 98 mol % or less, and more preferably 86 mol % or more and 98 mol % or less, and further preferably 91 mol % or more and 98 mol % or less.

When the isotactic pentad fraction is less than 80 mol %, rigidity of a molded sheet is liable to be short. On the other hand, when the isotactic pentad fraction is more than 98 mol %, transparency is liable to be reduced.

If the isotactic pentad fraction is within the above-described range, high transparency is obtained and the laminate is easily favorably decorated.

The term “isotactic pentad fraction” means an isotactic fraction in a pentad unit (5 propylene monomers are continuously linked in an isotactic sequence) in molecular chains of a resin composition. A measuring method of the fraction is described in Macromolecules, vol. 8, p. 687 (1975), for example. The fraction can be measured by ¹³C-NMR. The isotactic pentad fraction is measured by the method described in Examples.

If a crystallization rate at 130° C. is 2.5 min⁻¹ or less, such polypropylene is preferred from a viewpoint of moldability.

The crystallization rate of the polypropylene is preferably 2.5 min⁻¹ or less, and more preferably 2.0 min⁻¹ or less. If the crystallization rate is 2.5 min⁻¹ or less, rapid curing of a portion in contact with a mold or the like can be suppressed, and deterioration in design performance can be prevented.

The crystallization rate is measured by the method described in Examples.

As a crystal structure of the polypropylene, the polypropylene preferably contains a smectic form. The smectic form is in a mesophase in a metastable state, and each domain size is small, whereby a molded product has excellent transparency, and therefore such a state is preferred. Further, the smectic form is in the metastable state, and therefore the sheet is softened at lower quantity of heat in comparison with an a form in which crystallization is progressed, whereby such polypropylene has excellent moldability, and therefore such a state is preferred.

In addition thereto, the polypropylene may contain any other crystal form such as a β form, a γ form and an amorphous portion.

Then, 30 mass % or more, 50 mass % or more, 70 mass % or more or 90 mass % or more of the polypropylene resin layer may be in the smectic form.

The crystal structure of the polypropylene is identified by the method described in Examples.

The polypropylene has an exothermic peak having preferably 1.0 J/g or more, and more preferably 1.5 J/g or more on a low-temperature side of a maximum endothermic peak in a curve of differential scanning calorimetry. An upper limit is not particularly limited, but is ordinarily 10 J/g or less.

The exothermic peak is measured using a differential scanning calorimeter by the method described in Examples.

Further, the polyolefin resin layer preferably contains no nucleating agent. Even if the polyolefin resin layer contains the nucleating agent, a content of the nucleating agent in the polyolefin resin layer is preferably 1.0 mass % or less, and more preferably 0.5 mass % or less.

Examples of the nucleating agent include a sorbitol-based nucleating agent, and specific examples of a commercial item thereof include GEL ALL MD (New Japan Chemical Co., Ltd.), Rikemaster FC-1 (Riken Vitamin Co., Ltd.), and the like.

The crystallization rate of the polypropylene is adjusted to 2.5 min⁻¹ or less, and the polypropylene is cooled at 80° C./s (second) or more to form the smectic form, without adding the nucleating agent, whereby the laminate excellent in the design performance can be obtained. Further, if the laminate is heated and then shaped in the method for producing the molded article described later, the polyolefin resin layer is transformed into the α form while a fine structure derived from the smectic form is maintained. Surface hardness or transparency can be further improved by this transformation.

In order to obtain the polypropylene excellent in transparency and gloss at the isotactic pentad fraction of 80 mol % or more and 98 mol % or less and at the crystallization rate of 2.5 min⁻¹ or less, formation of the smectic form is ordinarily necessary. In the method for producing the molded article described later, the polypropylene is transformed into the α form while the fine structure derived from the smectic form is maintained by shaping after heating, and if the polypropylene in the molded article has the isotactic pentad fraction of 80 mol % or more and 98 mol % or less and if the crystallization rate of 2.5 min⁻¹ or less, it is considered that the polypropylene is derived from the smectic form.

A scattering intensity distribution and a long period are calculated by a small-angle X-ray scattering analysis method, whereby whether or not the polyolefin resin layer is a material obtained by cooling at 80° C./s or more can be judged. More specifically, according to the above-described analysis, whether or not the polyolefin resin layer has the fine structure derived from the smectic form can be judged. Measurement is performed under the conditions described below.

As an X-ray generator, UltraX 18HF (manufactured by Rigaku Corporation) is used, and an imaging plate is used for detection of scattering.

Light source wavelength: 0.154 nm

Voltage/current: 50 kV/250 mA

Irradiation time: 60 minutes

Camera length: 1.085 m

Sample thickness: sheets are stacked to be 1.5 to 2.0 mm. Further, the sheets are stacked so as to align film-forming (MD) directions.

In addition, in order to shorten a measuring time, the sheets are stacked to be 1.5 to 2.0 mm, but if the measuring time is prolonged, the sample thickness can be measured even with one sheet without stacking the sheets.

Specific examples of a method for forming the polyolefin resin layer include an extrusion method.

Cooling is preferably performed at 80° C./s or more, and is performed until an internal temperature of the polyolefin resin layer reaches a crystallization temperature or less. Thus, the crystal structure of the polyolefin resin layer (particularly, polypropylene) can be formed into the smectic form described above. Cooling is performed more preferably at 90° C./s or more, and more preferably 150° C./s or more.

The cyclic polyolefin is a polymer containing a structural unit derived from cyclic olefin, or may be a copolymer with ethylene (cyclic polyolefin copolymer).

A melt flow rate (hereinafter, also referred to as “MFR”) of the polypropylene is preferably in the range of 0.5 to 10 g/10 min. If the melt flow rate is within this range, the polypropylene is excellent in moldability to a film shape or a sheet shape. MFR of the polypropylene is measured at a measuring temperature of 230° C. and a load of 2.16 kg in accordance with JIS K 7210.

MFR of the polyethylene can be adjusted to 0.1 to 10 g/10 min. If MFR is within this range, the polyethylene is excellent in moldability to the film shape or the sheet shape. MFR of the polyethylene is measured at 190° C. and a load of 2.16 kg in accordance with JIS K 7210.

MFR of the cyclic polyolefin can be adjusted to 0.5 to 15 g/10 min. MFR of the cyclic polyolefin is measured at 230° C. and a load of 2.16 kg in accordance with ISO1133.

An additive such as a pigment, an antioxidant, a stabilizer, an ultraviolet light absorber and the like may be blended, when necessary, in the polyolefin.

Further, a modified polyolefin resin obtained by modifying the polyolefin with a modifying compound such as, for example, maleic anhydride, dimethyl maleate, diethyl maleate, acrylic acid, methacrylic acid, tetrahydrophthalic acid, glycidyl methacrylate, hydroxyethyl methacrylate, methyl methacrylate and the like may be blended in the polyolefin.

A thickness of the polyolefin resin layer is ordinarily 10 to 1000 μm, or may be adjusted to 15 to 500 μm, 60 to 250 μm or 75 to 220 μm.

In the polyolefin resin layer, the materials described above may be used in one kind alone, or in combination of two or more kinds. Further, the polyolefin resin layer may contain a resin other than the polyolefin.

### (Adhesive Layer)

The adhesive layer is a layer that can improve adhesion between the polyolefin resin layer and the undercoat layer.

In addition, a resin contained in the adhesive layer and a resin contained in the polyolefin resin layer are ordinarily different from each other, and the resin contained in the adhesive layer and a resin contained in the undercoat layer are ordinarily different from each other. The expression “resins are different” means not only a case where kinds of resins are different, but also a case where physical properties are different even in the same kind of resins. Further, when two or more kinds of resins are contained in one layer, even if the kind is partly or wholly the same as a kind in the other layer, if the compositions are different from each other, the resins are to be different.

Specific examples of the material that forms the adhesive layer include a urethane-based resin, an acrylic resin, a polyolefin-based resin, a polyester-based resin and the like. These resins satisfy values of the physical properties such as the glass transition temperature, the tensile elongation at break and the softening temperature described later, and therefore can improve the adhesion between the polyolefin resin layer and the undercoat layer. Among these materials, a urethane-based resin is preferred in consideration of the adhesion to the polyolefin resin layer, the undercoat layer or a printed layer, or the moldability.

In the adhesive layer, the materials described above may be used in one kind alone, or in combination of two or more kinds.

Then, 80 mass % or more, 90 mass % or more, 95 mass % or more, 98 mass % or more, 99 mass % or more, 99.5 mass % or more, 99.9 mass % or more or 100 mass % of the adhesive layer may be formed of one or more resins (for example, a urethane resin) selected from the group consisting of the urethane-based resin, the acrylic resin, the polyolefin-based resin and the polyester-based resin.

The urethane-based resin is ordinarily obtained by allowing at least diisocyanate, high molecular weight polyol and a chain extending agent to react. Polyether polyol or polycarbonate polyol may be used as the high molecular weight polyol.

Even when the laminate is molded into a complicated non-planar shape, the adhesive layer is provided, whereby the adhesive layer can follow the polyolefin resin layer to favorably form a layer structure, and inconvenience in which crazing or peeling is caused in the undercoat layer and the metal layer can be prevented.

A glass transition temperature of the adhesive layer is preferably −100° C. or higher and 100° C. or lower. If the glass transition temperature is −100° C. or higher, strain of the adhesive layer is not over followability of the metal layer, and therefore a defect caused by crazing is not caused even if a product is used for a long period of time. If the glass transition temperature is 100° C. or lower, a softening temperature is appropriate, and therefore stretching during preliminarily shaping is favorable, and stretch unevenness of a stretched portion or crazing of the metal layer can be prevented.

The glass transition temperature is measured by the method described in Examples.

The tensile elongation at break of the adhesive layer is 150% or more and 900% or less, preferably 200% or more and 850%, and more preferably 300% or more and 750% or less, for example.

If the tensile elongation at break of the adhesive layer is 150% or more, the adhesive layer can sufficiently follow stretching of the polyolefin resin layer during thermoforming, whereby crazing of the adhesive layer and crazing or peeling of the metal layer can be suppressed. If the tensile elongation at break is 900% or less, the laminate is excellent in water resistance.

The tensile elongation at break is measured by the method described in Examples.

The softening temperature of the adhesive layer is 50° C. or higher and 180° C. or lower, preferably 90° C. or higher and 170° C. or lower, and more preferably 100° C. or higher and 165° C. or lower, for example.

If the softening temperature is 50° C. or higher, the adhesive layer is excellent in strength at an ordinary temperature, and crazing or peeling of the metal layer can be suppressed. If the softening temperature is 180° C. or lower, the adhesive layer is sufficiently softened during thermoforming, and therefore crazing of the adhesive layer and crazing or peeling of the metal layer can be suppressed.

The softening temperature of the adhesive layer is measured by the method described in Examples.

The adhesive layer can be formed by applying the resin described above with a gravure coater, a kiss coater, a bar coater or the like, and by drying the layer at 40 to 100° C. for 10 seconds to 10 minutes, for example.

A thickness of the adhesive layer may be adjusted to 35 nm or more and 3000 nm or less, or may be adjusted to 50 nm or more and 2000 nm or less, or may be adjusted to 50 nm or more and 1000 nm or less.

If the thickness of the adhesive layer is 35 nm or more, the adhesion with the undercoat layer or a screen ink is sufficiently high. If the thickness of the adhesive layer is 3000 nm or less, blocking caused by stickiness can be suppressed.

On the adhesive layer (on a side opposite to the polyolefin resin layer), various coatings such as an ink or hard coat, an antireflection coat and a thermal insulation coat can be laminated.

Further, another layer (second adhesive layer) may be provided on a surface on a side opposite to the above-described adhesive layer (first adhesive layer) across the polyolefin resin layer. Thus, the polyolefin resin layer to be the surface of the molded article is provided with functionality such as surface treatment or hard coating.

### (Undercoat Layer)

The undercoat layer is a layer that can adhere the adhesive layer to the metal layer. The undercoat layer is provided, whereby innumerable significantly fine cracks can be generated in the metal layer even when stress is applied during thermoforming, and the rainbow phenomenon can be eliminated or reduced.

Specific examples of materials that form the undercoat layer include a urethane resin, an acrylic resin, a polyolefin and polyester. These resins can satisfy the glass transition temperature described later, and can exhibit the effects described above. Among these materials, from viewpoints of whitening resistance (difficulty in occurrence of the whitening phenomenon) during molding and the adhesion with the metal layer, an acrylic resin is preferred, and “DA-105” manufactured by Arakawa Chemical Industries, Ltd. can be used, for example.

The above-described materials may be used in one kind alone, or in combination of two or more kinds.

The glass transition temperature of the undercoat layer is preferably 0° C. or higher and 100° C. or lower. If the glass transition temperature is 0° C. or higher, strain of the undercoat layer is not over followability of the metal layer, and therefore the defect caused by crazing is not generated even if the product is used for a long period of time. If the glass transition temperature is 100° C. or lower, the softening temperature is appropriate, and therefore stretching during preliminarily shaping is favorable, and stretching unevenness of the stretched portion or crazing of the metal layer can be prevented. The glass transition temperature is measured by the method described in Examples.

In the undercoat layer, the resin component (main agent) described above may be used in combination with a curing agent. Specific examples of the curing agent include an aziridine-based compound, a blocked isocyanate compound, an epoxy-based compound, an oxazoline compound, a carbodiimide compound and the like, and “CL102H” manufactured by Arakawa Chemical Industries, Ltd. can be used, for example.

When the curing agent is used, a content proportion of the main agent to the curing agent in the undercoat layer is 35:4 to 35:40, preferably 35:4 to 35:32, and more preferably 35:12 to 35:32 in a mass ratio in terms of solid content, for example. Further, the content proportion may be adjusted to 35:12 to 35:20.

If a blending amount of the curing agent is 4 or more relative to 35 of the main agent, a curing reaction is sufficiently progressed, and the whitening resistance can be further maintained. If the blending amount is 40 or less, stretchability of the undercoat layer is more favorable, and crazing during molding can be further suppressed.

The content proportion of the main agent to the curing agent of the undercoat layer in the laminate or the molded article can be calculated from an absorbance ratio of peaks derived from the main agent and the curing agent by Fourier Transform Infrared Spectroscopy (FTIR). Measurement is performed under the following conditions.

As a measuring device, “FT/IR-6100” manufactured by JASCO Corporation is used, and a sheet surface on the undercoat layer side is adhered to a prism to obtain an absorption spectrum by Attenuated Total Reflection (ATR). Samples in which the content proportions of the main agent to the curing agent are changed are previously arranged, and a calibration curve is created by using the measured absorbance ratios of the peaks derived from the main agent and the curing agent to determine the content proportion of the main agent to the curing agent.

Then, 80 mass % or more, 90 mass % or more, 95 mass % or more, 98 mass % or more, 99 mass % or more, 99.5 mass % or more, 99.9 mass % or more or 100 mass % of the undercoat layer may consist of the above-described resin component (for example, the acrylic resin), or may consist essentially of the resin component and the curing agent.

As a method for forming the undercoat layer, for example, the material described above is applied with a gravure coater, a kiss coater or a bar coater, and the coating is dried at 50 to 100° C. for 10 seconds to 10 minutes, and aged at 40 to 100° C. for 10 to 200 hours, whereby the undercoat layer can be formed.

A thickness of the undercoat layer may be adjusted to 0.05 μm to 50 μm, or 0.1 μm to 10 μm, or 0.5 μm to 5 μm.

### (Metal Layer)

The metal layer is a layer that contains metal or metal oxide.

The metal that forms the metal layer is not particularly limited, as long as the metal can provide the laminate with a metal-like design, and specific examples thereof include tin, indium, chromium, aluminum, nickel, copper, silver, gold, platinum, and zinc, and alloy containing at least one kind thereof may be used.

Among the above-described materials, indium, aluminum and chromium are particularly excellent in extensibility and a color tone, and therefore are preferred. If the metal layer is excellent in the extensibility, crazing is hard to be caused upon three-dimensionally molding the laminate.

A method for forming the metal layer is not particularly limited, but from a viewpoint of providing the laminate with the metal-like design having high texture and high-class impression, for example, a vapor deposition method such as a vacuum deposition method, a sputtering method and an ion plating method, or the like, using the above-described metal, can be used. In particular, the vacuum deposition method can be performed at low cost and small damage to a body to be deposited. Depositing conditions should be appropriately set according to a melting temperature or an evaporating temperature of the metal to be used.

In addition to the above-described methods, a method for coating paste containing the above-described metal or metal oxide, a plating method using the above-described metal, or the like can be used.

The metal layer may be partly or wholly provided on the layer to be formed.

A thickness of the metal layer may be adjusted to 5 nm or more and 80 nm or less. If the thickness is 5 nm or more, desired metallic gloss is easily obtained, and if the thickness is 80 nm or less, crazing is hard to be caused.

### (Printed Layer)

The laminate according to one aspect of the invention may comprise the printed layer. The printed layer can be provided on one surface of the metal layer, namely, a surface on a side of the undercoat layer or a surface on a side opposite to the undercoat layer, for example. The printed layer may be provided partly or wholly on the surface of the metal layer. A shape of the printed layer is not particularly limited, and specific examples thereof include various shapes such as a solid shape, a carbon-like shape and a wood grain shape.

As a printing method, a general printing method such as a screen printing method, an offset printing method, a gravure printing method, a roll coating method and a spray coating method can be used. In particular, in the screen printing method, an ink film thickness can be increased, and therefore an ink crack is hard to be generated upon molding the laminate into a complicated shape.

For example, in the case of the screen printing, ink excellent in stretching during molding is preferred, and specific examples thereof can include “FM3107 high concentration white” and “SIM3207 high concentration white,” manufactured by Jujo Chemical Co., Ltd., but are not limited thereto.

The laminate according to one aspect of the invention may consist of the polyolefin resin layer, the adhesive layer, the undercoat layer and the metal layer, or may consist of the polyolefin resin layer, the adhesive layer, the undercoat layer, the metal layer and the printed layer.

### [Method for Producing Laminate]

A method for producing the laminate according to one aspect of the invention is not particularly limited, but the polyolefin resin layer is formed by the method described in Examples, and each layer is provided thereon by the method described above, whereby the laminate can be produced, for example.

### [Molded Article]

The molded article can be prepared by using the laminate described above.

In the molded article of the invention, when the polyolefin resin layer contains the polypropylene, the isotactic pentad fraction of the polypropylene is preferably 80 mol % or more and 98 mol % or less.

Further, the crystallization rate of the polypropylene at 130° C. is preferably 2.5 min⁻¹ or less, and more preferably 2.0 min⁻¹ or less.

A portion corresponding to the polyolefin resin layer of the laminate can be identified by using a phase microscope or the like even after the molded article is formed.

Glossiness of the molded article according to one aspect of the invention can be adjusted, when indium or indium oxide is used for the metal layer, to 250% or more, 300% or more, 400% or more, 500% or more or 600% or more, for example. If the glossiness of the molded article is 250% or more, sufficient metallic gloss is exhibited and an excellent metal-like design can be provided for the molded article.

Measurement of the glossiness is performed by the method described in Examples.

The glossiness of the molded article according to one aspect of the invention may be adjusted, when aluminum or aluminum oxide is used for the metal layer, to 460% or more, 480% or more, 500% or more or 520% or more, for example. If the glossiness of the molded article is 460% or more, the metallic gloss is sufficiently exhibited and the excellent metal-like design can be provided for the molded article.

The glossiness of the molded article according to one aspect of the invention may be adjusted, when chromium or chromium oxide is used for the metal layer, to 150% or more, 180% or more, 200% or more or 220% or more, for example. If the glossiness of the molded article is 150% or more, the metallic gloss is sufficiently exhibited and the excellent metal-like design can be provided for the molded article.

### [Method for Producing Molded Article]

Specific examples of the method for producing the molded article according to one aspect of the invention include in-mold molding, insert molding and coating molding.

The in-mold molding is a method of placing the laminate in the mold, and molding the laminate into a desired shape by pressure of the molding resin to be supplied into the mold to obtain the molded article.

The in-mold molding is preferably performed by attaching the laminate to the mold and supplying the molding resin to integrate the molding resin with the laminate.

The insert molding is a method of preliminarily shaping a body to be shaped to be placed in the mold, and filling the molding resin in the shape to obtain the molded article. The insert molding can provide a further complicated shape.

The insert molding can be performed by shaping the laminate so as to match the mold, attaching the shaped laminate to the mold, and supplying the molding resin to integrate the molding resin with the shaped laminate.

The shaping (preliminary shaping) so as to match the mold can be performed by vacuum forming, pressure forming, vacuum and pressure forming, press molding, plug-assist molding, or the like.

As the molding resin, a moldable thermoplastic resin can be used. Specific examples thereof include polypropylene, polyethylene, polycarbonate, an acetylene-styrene-butadiene copolymer and an acrylic polymer, but are not limited thereto. A fiber or an inorganic filler such as talc may be added thereto.

Supplying is preferably performed by injection, and pressure is preferably 5 MPa or more and 120 MPa or less. A mold temperature is preferably 20° C. or higher and 90° C. or lower.

The coating molding includes arranging a core material in a chamber box, arranging the laminate above the core material, reducing pressure in the chamber box, heating and softening the laminate, bringing the laminate into contact with an upper surface of the core material, and pressing the heated and softened laminate to the core material to coat the laminate on the core material.

After heating and softening the laminate, the laminate may be brought into contact with the upper surface of the core material. Pressing can be performed by, in the chamber box, pressurizing a side opposite to the core material across the laminate while keeping a side in contact with the core material of the laminate in reduced pressure.

The core material may be in a convex form or a concave form, and specific examples thereof include a resin, metal and ceramic having a three-dimensional curve. Specific examples of the resin include a resin similar to the resin used for the molding described above.

As the above-described method, specifically, the chamber box configured of upper and lower two molding chambers separable from each other can be used.

First, the core material is placed and set on a table in the lower molding chamber. The laminate according to one aspect of the invention being an object to be molded is fixed onto an upper surface of the lower molding chamber with a clamp. On the occasion, pressure inside the upper and lower molding chambers is atmospheric pressure.

Then, the upper molding chamber is descended to bond the upper and lower molding chambers into a closed state inside the chamber box. Both insides of the upper and lower molding chambers are formed into a vacuum suction state from an atmospheric pressure state by a vacuum tank.

After the insides of the upper and lower molding chambers are formed into the vacuum suction state, a decorative sheet is heated by turning on a heater. Then, the table in the lower molding chamber is ascended with keeping the insides of the upper and lower molding chambers in the vacuum state.

Then, vacuum inside the upper molding chamber is opened to introduce the atmospheric pressure thereinto, whereby the laminate according to one aspect of the invention being the object to be molded is pressed onto the core material and is overlaid (molded). In addition, compressed air is supplied into the upper molding chamber, whereby the laminate according to one aspect of the invention being the object to be molded can also be adhered onto the core material with larger force.

After completion of overlay, the heater is turned off, and vacuum inside the lower molding chamber is also opened and returned to the atmospheric pressure, and the upper molding chamber is ascended to take out a product in which a decorated and printed laminate is overlaid as a surface material.

[Application of Molded article and the Like]

The laminate and the molded article according to one aspect of the invention can be used for an interior material of a vehicle, an exterior material, a housing of home electronics, a decorative steel plate, a decorative sheet, household equipment and a housing of an information communication device.

### EXAMPLES

### Example 1

### [Production of Laminate]

A laminate was produced according to procedures described below.

### (Polyolefin Resin Layer)

A polypropylene sheet (polyolefin resin layer) 51 was produced by using a production apparatus shown in FIG. 2.

Operation of the apparatus will be described. A melted resin (polypropylene) extruded from a T-die 52 of an extruder is interposed between a metal endless belt 57 and a fourth cooling roll 56 on a first cooling roll 53. In this state, the melted resin is pressure-welded with the first cooling roll 53 and the fourth cooling roll 56 and simultaneously rapidly cooled. The polypropylene sheet is subsequently interposed between the metal endless belt 57 and the fourth cooling roll 56 in a circular arc part corresponding to a substantially lower semicircle of the fourth cooling roll 56, and pressure-welded in a planar form. The polypropylene sheet is pressure-welded in the planar form and cooled with the fourth cooling roll 56, and the polypropylene sheet adhered to the metal endless belt 57 is moved onto the second cooling roll 54 together with turning of the metal endless belt 57. In a manner similar to the above description, the polypropylene sheet is pressure-welded in a planar form with the metal endless belt 57 in a circular arc part corresponding to a substantially upper semicircle of the second cooling roll 54, and cooled again, and the polypropylene sheet cooled on the second cooling roll 54 is then peeled from the metal endless belt 57. In addition, an elastic material 62 made of nitrile-butadiene rubber (NBR) is coated on surfaces of the first cooling roll 53 and the second cooling roll 54.

Production conditions of the polypropylene sheet 51 are as described below.

Diameter of the extruder: 150 mm

Width of the T-die 52: 1400 mm

Polypropylene (“Prime Polypro F-133A,” manufactured by Prime Polymer Co., Ltd., MFR: 3 g/10 min, homopolypropylene)

Thickness: 200 μm

Take-off speed of the polypropylene sheet 51: 25 m/min

Surface temperature of the fourth cooling roll 56 and the metal endless belt 57: 17° C.

Colling rate: 10,800° C./min

No nucleating agent is included

A crystallization rate was measured on the polypropylene used in the polyolefin resin layer using a differential scanning calorimeter (DSC) (“Diamond DSC,” manufactured by PerkinElmer, Inc.). Specifically, the polypropylene was heated from 50° C. to 230° C. at 10° C./min, held at 230° C. for 5 minutes, and cooled from 230° C. to 130° C. at 80° C./min, and then crystallized by being held at 130° C. Measurement was started on a heat quantity change from a time point at which the polypropylene reached 130° C. to obtain a DSC curve. The crystallization rate was determined from the DSC curve obtained according to procedures (i) to (iv) described below.

(i) A line obtained by approximating, by a straight line, a heat quantity change from a time point of 10 times the time from starting of measurement to a maximum peak top to a time point of 20 times the time was applied as a baseline.

(ii) An intersection point between a tangent having an inclination at an inflection point of a peak and the baseline was determined to determine a crystallization starting time and a crystallization ending time.

(iii) A time from the crystallization starting time obtained to a peak top was measured as a crystallization time.

(iv) The crystallization rate was determined from a reciprocal of the crystallization time obtained.

The crystallization rate of the polypropylene used in the polyolefin resin layer was 0.9 min⁻¹.

### (Isotactic Pentad Fraction)

A ¹³C-NMR spectrum was evaluated on the polypropylene used in the polyolefin resin layer to measure an isotactic pentad fraction. Specifically, according to attribution of peaks proposed in “Macromolecules, 8, 687 (1975)” by A. Zambelli et al., the measurement was performed using an apparatus, conditions and a calculation formula as described below.

### (Apparatus and Conditions)

Apparatus: ¹³C-NMR spectrometer (“JNM-EX400” model, manufactured by JEOL Ltd.)

Method: complete proton decoupling method (concentration: 220 mg/mL)

Solvent: mixed solvent of 1,2,4-trichlorobenzene and hexadeuterobenzene (90:10 (volume ratio))

Temperature: 130° C.

Pulse width: 45°

Pulse repetition time: 4 seconds

Accumulation: 10,000 times

### (Calculation Formula)

Isotactic pentad fraction[mmmm]=m/S×100

(where, S represents signal intensity of side chain methyl carbon atoms in all propylene units, and m represents a meso pentad chain (21.7 to 22.5 ppm).)

The isotactic pentad fraction was 98 mol %.

### (Confirmation of Crystal Structure)

A crystal structure of the polypropylene in the polyolefin resin layer was confirmed by Wide-Angle X-ray Diffraction (WARD) with reference to the method by T. Konishi (Macromolecules, 38, 8749, 2005). An analysis was conducted on an X-ray diffraction profile by separating peaks in an amorphous phase, a mesophase and a crystal phase, respectively, to determine an existence ratio from a peak area attributed to each phase.

The polypropylene used in a decorative sheet obtained was confirmed to have a smectic form.

### (Differential Scanning Calorimetry)

Measurement was performed on the polypropylene used in the polyolefin resin layer using the same differential scanning calorimeter as the above-described differential scanning calorimeter in the measurement of the crystallization rate. Specifically, the polypropylene was heated from 50° C. to 230° C. at 10° C./min to observe an endothermic peak and an exothermic peak. If the endothermic and exothermic peaks obtained were observed, the polypropylene was confirmed to have the exothermic peak having 1.7 J/g on a lower temperature side of a maximum endothermic peak.

### (2) Adhesive Layer

Corona treatment was applied to the polypropylene sheet obtained, and then a urethane resin (trade name “HYDRAN WLS-202,” manufactured by DIC Corporation) was applied thereon with a bar coater to be 230 nm in a dried film thickness, and the resulting material was dried at 80° C. for 1 minute to form an adhesive layer.

The corona treatment was applied to the sheet surface by using a high frequency generator (high frequency generator “CT-0212,” manufactured by Wedge Co., Ltd.).

Tensile elongation at break of an adhesive layer was measured as described below. An aqueous solution containing the above-described urethane resin was applied onto a glass substrate with a bar coater, the resulting substrate was dried at 80° C. for 1 minute, then the urethane resin layer was separated from the glass substrate to prepare a sample having a thickness of 150 μm, and the tensile elongation at break was measured by the method in accordance with JIS K 7311 (1995). The tensile elongation at break of the urethane resin in the adhesive layer was 600%.

A softening temperature of the adhesive layer was determined by using a sample prepared in the same manner as in the measurement of the tensile elongation at break, and measuring a flow starting temperature by a Koka-type flowtester (“constant testing force extrusion shape capillary rheometer flowtester CFT-500EX,” manufactured by Shimadzu Corporation). The softening temperature of the urethane resin in the adhesive layer was 160° C.

A curve of differential scanning calorimetry was measured on the adhesive layer by using a sample prepared in the same manner as in the measurement of the tensile elongation at break, according to a differential scanning calorimeter (“DSC-7” manufactured by PerkinElmer Japan Co., Ltd.) under conditions described below to determine a glass transition temperature. The glass transition temperature of the urethane resin in the adhesive layer was −50° C.

Measurement starting temperature: −90° C.

Measurement ending temperature: 220° C.

Heating temperature: 10° C./min

### (3) Undercoat Layer

A main agent (resin component) and a curing agent described below were mixed to be 35:16 in the main agent:the curing agent (mass ratio) in terms of solid content. The mixture obtained was applied onto the above-described adhesive layer with a bar coater to be 1.2 μm in a dried film thickness, and the resulting material was dried at 80° C. for 1 minute, and aged at 60° C. for 24 hours to form an undercoat layer.

Main agent: trade name “DA-105,” manufactured by Arakawa Chemical Industries, Ltd.

Curing agent: trade name “CL102H,” manufactured by Arakawa Chemical Industries, Ltd.

The above-described main agent contains an acrylic resin and methyl ethyl ketone.

The above-described curing agent contains a curing agent (40 mass %), methyl ethyl ketone (20.1 mass %) and n-butyl acetate (39.1 mass %).

The above-described main agent of the undercoat layer was applied onto a glass substrate with a bar coater, and the resulting material was dried at 80° C. for 1 minute, and then separated to prepare a sample having a thickness of 20 μm. A curve of differential scanning calorimetry was measured by a differential scanning calorimeter (“Diamond DSC,” manufactured by PerkinElmer Japan Co., Ltd.) under conditions described below to determine a glass transition temperature. The glass transition temperature of the acrylic resin in the undercoat layer was 93° C.

Measurement starting temperature: −50° C.

Measurement ending temperature: 200° C.

Heating temperature: 10° C./min

### (4) Metal Layer

Aluminum was deposited, at a thickness of 50 nm, on the undercoat layer obtained to form a metal layer.

### [Evaluation of Laminate (Adhesion)]

In the laminate obtained, 11 cuts were formed at an interval of 1 mm on a surface on a side opposite to a surface in contact with the undercoat layer across the metal layer by using a utility knife. Further, 11 cuts were formed at an interval of 1 mm so as to be perpendicular to the previous cuts to prepare squares of 10×10.

A commercially available cellophane tape (“CT-24” (width: 24 mm) manufactured by Nichiban Co., Ltd.) was stuck onto the cuts, and was sufficiently adhered to the above-described cuts by a ball of a finger, and then the cellophane tape was peeled.

A ratio: (the number of remaining squares/the total number of squares (100 squares)) was expressed in terms of percentage, and adhesion was evaluated. The results are shown in Table 1.

### [Production of Molded Article]

The laminate obtained was thermoformed by vacuum and pressure forming using a vacuum pressure forming machine (“FM-3M/H,” manufactured by Minos Inc.) to produce a molded article.

### [Evaluation of Molded Article]

Evaluation described below was performed on the molded article obtained. The results are shown in Table 1.

### (Appearance of Molded Article)

An appearance was visually confirmed on the molded article obtained, and evaluated according to criteria described below.

Having metallic gloss: excellent

Having metallic gloss but reduced: good

Metallic gloss lost: poor

Further, when a surface on a side opposite to the undercoat across the metal layer was magnified and observed by using 3D Measuring Laser Microscope “OLS4000” manufactured by Olympus, Inc., it was confirmed that significantly fine cracks are innumerably generated in the metal layer, and that crazing having such a size as a visible level is not caused therein.

### (Presence or Absence of Rainbow)

Presence or absence of a rainbow phenomenon (rainbow luminance unevenness) was visually confirmed on the molded article obtained, and evaluated according to criteria described below.

No occurrence of rainbow phenomenon: good

Occurrence of rainbow phenomenon: poor

### (Glossiness)

Glossiness was determined on the molded article obtained, in accordance with JIS Z 8741 for the methods of measurement of specular gloss at an angle of 60°, in which Automatic Chroma Meter (AUD-CH-2 model-45, 60, manufactured by Suga Test Instruments Co., Ltd.) was used to irradiate the molded article with light, at an incident angle of 60 degrees, from a surface on a side opposite to a surface in contact with the adhesive layer across the polyolefin resin layer, thereby measuring a reflected light flux ψs when reflected light was received at the same angle of 60 degrees, and calculation was performed from a ratio of the reflected light flux ψs to a reflected light flux ψ0s from a glass surface having a refractive index of 1.567, according to the formula (1).

Glossiness(Gs)=(ψs/ψ0s)×100 (1)

### Example 2

A laminate and a molded article were produced and evaluated in the same manner as in Example 1 except that a mixing proportion of a main agent and a curing agent in an undercoat layer was adjusted to the main agent:the curing agent (mass ratio)=35:28. The results are shown in Table 1.

Further, when a surface on a side opposite to the undercoat across a metal layer was observed in the same manner as in Example 1, it was confirmed that significantly fine cracks are innumerably generated in the metal layer, and that crazing having such a size as a visible level is not caused therein.

### Example 3

A laminate and a molded article were produced and evaluated in the same manner as in Example 1 except that indium was used in a metal layer. The results are shown in Table 1.

Further, when a surface on a side opposite to an undercoat across the metal layer was observed in the same manner as in Example 1, it was confirmed that significantly fine cracks are innumerably generated in the metal layer, and that crazing having such a size as a visible level is not caused therein.

### Example 4

A laminate and a molded article were produced and evaluated in the same manner as in Example 1 except that chromium was used in a metal layer. The results are shown in Table 1.

When a surface on a side opposite to an undercoat across the metal layer was observed in the same manner as in Example 1, it was confirmed that significantly fine cracks are innumerably generated in the metal layer, and that crazing having such a size as a visible level is not caused therein.

### Comparative Example 1

A laminate and a molded article were produced and evaluated in the same manner as in Example 1 except that an undercoat layer was directly laminated on a polyolefin resin layer without laminating an adhesive layer. The results are shown in Table 1.

Further, when a surface on a side opposite to the undercoat across a metal layer was observed in the same manner as in Example 1, it was confirmed that significantly fine cracks are innumerably generated in the metal layer, and that crazing having such a size as a visible level is not caused therein.

### Comparative Example 2

A laminate and a molded article were produced and evaluated in the same manner as in Comparative Example 1 except that a mixing proportion of a main agent to a curing agent in an undercoat layer was adjusted to 35:28 in the main agent:the curing agent (mass ratio). The results are shown in Table 1.

Further, when a surface on a side opposite to the undercoat across a metal layer was observed in the same manner as in Example 1, it was confirmed that significantly fine cracks are innumerably generated in the metal layer, and that crazing having such a size as a visible level is not caused therein.

### Comparative Example 3

A laminate and a molded article were produced and evaluated in the same manner as in Example 1 except that a metal layer was directly laminated on an adhesive layer without laminating an undercoat layer. The results are shown in Table 1.

Further, when a surface on a side opposite to the undercoat across a metal layer was observed in the same manner as in Example 1, it was confirmed that visible large crazing is innumerably caused in the metal layer.

### Comparative Example 4

A laminate and a molded article were produced and evaluated in the same manner as in Example 1 except that a metal layer was directly laminated on a polyolefin resin layer without laminating an adhesive layer and an undercoat layer. The results are shown in Table 1.

Further, when a surface on a side opposite to the undercoat across a metal layer was observed in the same manner as in Example 1, it was confirmed that visible large crazing is innumerably caused in the metal layer.

TABLE 1

| | | | Example | | | | Comparative Example | | | |
|---|---|---|---|---|---|---|---|---|---|---|
| | | | 1 | 2 | 3 | 4 | 1 | 2 | 3 | 4 |
| Laminate | Polyolefin | Resin | Poly- | Poly- | Poly- | Poly- | Poly- | Poly- | Poly- | Poly- |
| | | | propylene | propylene | propylene | propylene | propylene | propylene | propylene | propylene |
| | resin layer | Thickness | 200 | 200 | 200 | 200 | 200 | 200 | 200 | 200 |
| | | (μm) | | | | | | | | |
| | Adhesive | Resin | Urethane | Urethane | Urethane | Urethane | — | — | Urethane | — |
| | layer | | resin | resin | resin | resin | | | resin | |
| | | Thickness | 230 | 230 | 230 | 230 | | | 230 | |
| | | (nm) | | | | | | | | |
| | Undercoat | Main agent | Acrylic | Acrylic | Acrylic | Acrylic | Acrylic | Acrylic | — | — |
| | layer | (resin | resin | resin | resin | resin | resin | resin | | |
| | | component) | | | | | | | | |
| | | Mixing ratio of | 35:16 | 35:28 | 35:16 | 35:16 | 35:16 | 35:28 | | |
| | | curing agent | | | | | | | | |
| | | (main agent: | | | | | | | | |
| | | curing agent | | | | | | | | |
| | | (mass ratio | | | | | | | | |
| | | in terms of | | | | | | | | |
| | | solid content)) | | | | | | | | |
| | | Thickness | 1.2 | 1.2 | 1.2 | 1.2 | 1.2 | 1.2 | | |
| | | (μm) | | | | | | | | |
| | Metal | Material | Aluminum | Aluminum | Indium | Chromium | Aluminum | Aluminum | Aluminum | Aluminum |
| | layer | Thickness (nm) | 50 | 50 | 50 | 50 | 50 | 50 | 50 | 50 |

| Evaluation of laminate | | 100 | 100 | 100 | 100 | 93 | 90 | 100 | 75 |
|---|---|---|---|---|---|---|---|---|---|
| (adhesion (%)) | | | | | | | | | |
| Evaluation | Appearance | excellent | good | excellent | good | good | good | poor | poor |
| of | Presence or absence | good | good | good | good | good | good | poor | poor |
| molded | of rainbow | | | | | | | | |
| article | Glossiness (%) | 614 | 503 | 650 | 223 | 457 | 442 | 330 | 324 |

Several embodiments and/or Examples of the present invention have been described in detail above, but those skilled in the art will readily make a great number of modifications to the exemplary embodiments and/or Examples without substantially departing from new teachings and advantageous effects of the invention. Accordingly, all such modifications are included within the scope of the invention.

The entire contents of the description of the Japanese application serving as a basis of claiming the priority concerning the present application to the Paris Convention are incorporated by reference herein.

1. A laminate, comprising, in the indicated order, a resin layer that contains a polyolefin, an adhesive layer, an undercoat layer and a metal layer that contains metal or metal oxide.

2. The laminate according to claim 1, wherein the adhesive layer contains one or more resins selected from the group consisting of a urethane resin, an acrylic resin, polyolefin and polyester.

3. The laminate according to claim 1, wherein the undercoat layer contains one or more resins selected from the group consisting of a urethane resin, an acrylic resin, polyolefin and polyester.

4. The laminate according to claim 1, wherein the undercoat layer contains a resin component and a curing agent component, and a content proportion of the resin component to the curing agent component is 35:4 to 35:40 in a mass ratio.

5. The laminate according to claim 1, wherein the resin layer that contains the polyolefin contains polypropylene.

6. The laminate according to claim 5, wherein an isotactic pentad fraction of the polypropylene is 80 mol % or more and 98 mol % or less.

7. The laminate according to claim 5, wherein a crystallization rate of the polypropylene at 130° C. is 2.5 min⁻¹ or less.

8. The laminate according to claim 5, wherein the polypropylene has an exothermic peak of 1.0 J/g or more on a low-temperature side of a maximum endothermic peak in a curve of differential scanning calorimetry.

9. The laminate according to claim 5, wherein the polypropylene contains a smectic form.

10. The laminate according to claim 1, wherein the resin layer that contains the polyolefin contains no nucleating agent.

11. The laminate according to claim 1, wherein a metal element contained in the metal layer is one or more selected from the group consisting of tin, indium, chromium, aluminum, nickel, copper, silver, gold, platinum and zinc.

12. The laminate according to claim 1, wherein a metal element contained in the metal layer is one or more selected from the group consisting of indium, aluminum and chromium.

13. The laminate according to claim 1, comprising a printed layer partly or wholly on a surface of the metal layer on a side opposite to the undercoat layer.

14. The laminate according to claim 1, comprising a printed layer partly or wholly on a surface of the metal layer on a side of the undercoat layer.

15. The laminate according to claim 1, comprising a second adhesive layer on a surface of the resin layer on a side opposite to the adhesive layer.

16. A molded article of the laminate according to claim 1.

17. The molded article according to claim 16, wherein the resin layer that contains the polyolefin in the molded article contains polypropylene, and an isotactic pentad fraction of the polypropylene is 80 mol % or more and 98 mol % or less.

18. The molded article according to claim 16, wherein the resin layer that contains the polyolefin in the molded article contains polypropylene, and a crystallization rate of the polypropylene at 130° C. is 2.5 min⁻¹ or less.

19. The molded article according to claim 16, wherein the metal layer in the molded article contains indium or indium oxide, and glossiness measured from a surface on a side opposite to the adhesive layer across the resin layer that contains the polyolefin is 250% or more.

20. The molded article according to claim 16, wherein the metal layer in the molded article contains aluminum or aluminum oxide, and glossiness measured from a surface on a side opposite to the adhesive layer across the resin layer that contains the polyolefin is 460% or more.

21. The molded article according to claim 16, wherein the metal layer in the molded article contains chromium or chromium oxide, and glossiness measured from a surface on a side opposite to the adhesive layer across the resin layer that contains the polyolefin is 200% or more.

22. A method for producing a molded article, comprising molding the laminate according to claim 1 to obtain the molded article.

23. The method for producing the molded article according to claim 22, wherein the molding is performed by attaching the laminate to a mold, and supplying a molding resin to integrate the molding resin with the laminate.

24. The method for producing the molded article according to claim 22, wherein the molding is performed by shaping the laminate so as to match a mold, attaching the shaped laminate to the mold, and supplying a molding resin to integrate the molding resin with the laminate.

25. The method for producing the molded article according to claim 22, wherein the molding comprises arranging a core material in a chamber box, arranging the laminate above the core material, reducing a pressure in the chamber box, heating and softening the laminate, and pressing the heated and softened laminate to the core material to coat the core material with the laminate.
